(19) United States
(12) Patent Application Publication
(10) Pub. No.: US 2006/0040675 A1
(43) Pub. Date: Feb. 23, 2006

(54) Method for operating a radio system, emitting station and radio system

(76) Inventors: Rudiger Halfmann, Otterberg (DE); Hui Li, Munchen (DE); Matthias Lott, Neuried (DE); Egon Schulz, Munchen (DE)

Correspondence Address: STAAS & HALSEY LLP, SUITE 700, 1201 NEW YORK AVENUE, N.W., WASHINGTON, DC, 20005, US

(21) Appl. No.: 10/524,289

(22) PCT Filed: Jul. 16, 2003
(86) PCT No.: PCT/EP03/07738

§ 371 Date: Aug. 12, 2005

(30) Foreign Application Priority Data
Aug. 13, 2002 (EP) 02018095.6

(51) Int. Cl. H04Q 7/20; H04M 1/00

(52) U.S. Cl. 455/456.1; 455/562.1

(57) ABSTRACT

In a radio system having stations which are at least partially provided with a directional antenna, a first emitting station is provided with a directional antenna in a first spatial radio area. The first emitting station sends a direction information message indicating the spatial direction in which the data is to be transmitted. Transmission resources can be advantageously occupied based on the direction information message.

### CROSS REFERENCE TO RELATED APPLICATIONS

This application is based on and hereby claims priority to European Application No. 02018095.6 filed on Aug. 13, 2002, the contents of which are hereby incorporated by reference.

### BACKGROUND OF THE INVENTION

1. Field of the Invention

The invention relates to a method for operating a radio system with at least some stations which are equipped with a directional antenna as well as to a corresponding emitting station and a corresponding radio system.

2. Description of the Related Art

In radio systems both signaling data and organizational information (for example control signals or information about the quality of the connection) and also payload data (for example speech, picture information or other data) is transmitted by electromagnetic waves over a radio interface between sending and receiving station.

Radio systems are for example cellular mobile radio systems such as GSM (Global system for Mobile communications) and UMTS (Universal Mobile Telecommunications System). Here data and data packets are transmitted by base stations which define a cellular structure from the fixed network over an air interface to mobile stations. The base stations in such cases have omnidirectional antennas, i.e. antennas which emit in all spatial directions and/or directional antennas which make it possible to emit the radio signals in a defined direction.

Furthermore Wireless Local Area Networks (WLANs) are known, for which two basic modes of operation exist:
1. Access to other networks and thereby data transfer between different radio networks is made possible by an infrastructure network. The infrastructure network can additionally be responsible for the control of access to the network components of the networks involved.
2. A network in the form of a self-organizing network (also called an ad-hoc network) dispenses with a network infrastructure. Subscriber devices of an ad-hoc network can communicate with each other provided they are in the mutual radio area or further subscriber devices can forward the data. Access to other networks is possible in combination with an Infrastructure network.

If a wireless local area network is implemented using an infrastructure network there is communication between subscriber devices and access points, with the access points, as well as controlling the radio transmission, also establishing the connection to other wired or wireless networks.

In ad-hoc networks a number of subscriber devices are able to establish a radio connection between themselves even without access points. The connection between two subscriber devices is made here either directly or over longer distances via further similar subscriber devices which form relay stations for these connections. The subscriber devices of a ad-hoc network can be mobile stations (for example mobile radio devices of people or in vehicles) and/or primarily stationary stations (for example computers, printers, home appliances). Ad-hoc networks are implemented for example in wireless local area networks such as HiperLAN and IEEE 802.11. Such wireless local area networks are not only used in the normal Internet and telematics area but also in the area of communication between vehicles, such as for example in hazard warning systems or cooperative driver assistance systems.

In ad-hoc networks with a frame structure access to the radio interface is in transmission frames. In this case a first subscriber device signals during the signaling phase of a transmission frame with a request-to-send the time interval in which it wishes to transmit data in the subsequent data transmission phase of the transmission frame. Further subscriber devices in the radio area of the first subscriber device which also wish to transmit during the data transmission phase of the time frame receive the information about the time interval and reserve further consecutive time intervals in the data transmission phase. The individual time intervals are arranged next to each other within the data transmission phase of the transmission frame. The maximum volume of data which can be sent during a data transmission phase of a transmission frame is determined in this case by the length of the data transmission phase. In an extreme case only one subscriber transmits per data transmission phase so that the subscribers are distributed over a number of data transmission phases. Thus transmission pauses of several data transmission phases can occur for the individual subscribers.

In Y. -B. Ko et al., “Medium Access Control Protocols Using Directional Antennas in Ad Hoc Networks”, Proceedings of the IEEE INFOCOM 2000, March 2000, a Request-To-Send (RTS) is transmitted from a first station to a second station via a directional antenna in an ad-hoc network, in which all stations possess a number of directional antennas. Together with the request-to-send the first station transmits its physical position as well as the duration of the data transmission. If the second station acknowledges the request-to-send the first station transmits its data to the second station for the specified duration. If a third station receives the request-to-send from the first station, the third station blocks its directional antenna which is pointing in the direction of the first station during data transmission from the first station to the second station. Directional antennas which are not pointing in the direction of the first station during data transmission from the first station to the second station can be used by the third station.

R. R. Choudhury describes in “Using Directional antenna for Medium Access Control in Ad hoc Networks”, Technical Report of Texas A&M University to BBN Technologies, March 2002, an ad-hoc network with stations with antenna systems which can be operated in omni mode or directional mode. Omni mode means that exclusively reception is omnidirectional, i.e. omnidirectional transmission is not possible. Directional mode means that both transmission and reception are possible in respect of a specifiable direction. A first station wishing to send sends a request-to-send in the direction of a second station. Since all stations of the ad-hoc network have antennas which can determine on the basis of a received signal the direction from which the signal came, the second station can also use a directional antenna pointing in the direction of the first station to acknowledge the request-to-send to the first station. The first station then sends data to the second station. If another station which is in omni mode receives the request-to-send of the first station, it computes the direction from which the first signal came and prevents itself transmitting data in the direction of the first station while the latter is transmitting data to the second station.

Transmission resources can also be seized in the way described in the article by Soheila V. Bana and Pravin Varaiya, “Space Division Multiple Access (SDMA) for Robust Ad hoc Vehicle Communication Networks”, IEEE fourth international conference on intelligent transportation systems, on the basis of a geographical position of a station with a request-to-send. This article describes an SDMA method in which each geographical position or area is assigned a time interval or a frequency on a one-to-one basis. If a station with a request-to-send is assigned a certain time interval, the temporal position of the time interval relative to further time intervals is produced directly by the geographical position of the station with the request-to-send.

### SUMMARY OF THE INVENTION

An object of the invention is to specify a method with which transmission resources can be better utilized.

In the inventive method for operating a radio system with stations, a first emitting station is equipped with a directional antenna. The first emitting station provides for transmission of data to a first receiving station by the directional antenna in a first spatial radio area and broadcasts directional information which reveals the spatial direction in which it is providing for the transmission of the data. On the basis of the broadcast directional information transmission resources can advantageously be seized. For example, with a centrally-controlled access method a control station which receives corresponding directional information from a number of stations can take account of this directional information for the occupation of transmission resources by the stations. Furthermore a control station in a locally-organized system can receive the directional information of a number of stations and forward it in a broadcast to all stations or itself seize transmission resources corresponding to the directional information.

If a second emitting station in particular receives the directional information, the directional information is advantageously taken into account for its occupation of transmission resources. The second emitting station can for example favorably seize transmission resources for its own data transmission.

If the second emitting station is equipped with a directional antenna and it provides for transmission of data to a second receiving station by its directional antenna in a second spatial radio area, it is advantageous for the second emitting station to check on the basis of the directional information of the first emitting station whether the first and the second spatial radio area overlap at one of the receiving stations. The first and second emitting station can then transmit their data in accordance with the invention such that the transmission only occurs simultaneously if the first and the second spatial radio area do not overlap at any of the receiving stations. In this way, in the event of the first and second radio areas being suitable, data which without the invention would have to have been transmitted consecutively can be transmitted simultaneously.

An especially advantageous embodiment of the invention is produced if the second emitting station (also) broadcasts directional information from which the spatial direction in which it provides for the transmission of its data can be derived. Further stations now have the opportunity of receiving the directional information of the first and second emitting station and can seize their transmission resources by evaluating the two items of directional information.

In a further embodiment of the invention the stations of the radio system broadcast position information about their geographical position. This signal can be received by all stations and can be used together with directional information from emitting stations for occupying transmission resources, especially for checking the overlapping of the spatial radio areas.

Advantageously the first emitting station broadcasts information about a time interval provided for transmission of its data to the first receiving station. Stations which receive this information then know how the first emitting station is planning the timing sequence of its data transmission.

If the second emitting station also sends information, after checking the overlapping of the first and second spatial radio area, about a time interval provided for transmission of its data to the second received station, both time intervals can be taken into account by the stations which have received the broadcast of the first and the second emitting station for the occupation of their transmission resources.

In a further advantageous embodiment of the invention the direction information specifies the geographical position of the emitting station in each case and the relevant spatial direction in which the signals are to be radiated. Stations which receive this type of direction information thus have a current geographical position of the emitting station available to them in each case and have a lower processing overhead since the relevant spatial direction in which the signals are emitted can be taken directly from the direction information and does not have to be computed.

It is further of advantage for the direction information to alternatively or additionally specify the geographical position of the relevant receiving station. In this way a possible current geographical position of the receiving station can be used for checking the overlapping of the radio areas.

In a radio system in which different types of directional antennas are used it is expedient for the direction information to contain antenna information about the characteristics of the directional antenna used. The radiation characteristics of the antenna used can than be read off directly from the antenna used and can be used to determine the associated radio area.

The invention can be executed advantageously if the radio system is a cellular or a wireless local area network.

Advantageously at least one of the emitting stations and/or at least one of the receiving stations is a mobile station.

The emitting station and the radio system are equipped with the components necessary for executing the method.

### BRIEF DESCRIPTION OF THE DRAWINGS

These and other objects and advantages of the present invention will become more apparent and more readily appreciated from the following description of exemplary embodiments, taken in conjunction with the accompanying drawings of which:

FIG. 1 is a block diagram of a first operating state of a radio system operating in accordance with an aspect of the inventive method,

FIG. 2 is a schematic diagram of a second operating state of the radio system,

FIG. 3 is a block diagram of an emitting station in accordance with an aspect of the invention.

### DETAILED DESCRIPTION OF THE PREFERRED EMBODIMENT

The invention will be described below with reference to an ad-hoc network. Naturally the invention can also be used in other radio systems. This applies especially to wireless local area networks as well as to GSM, UMTS and 4th-generation mobile radio systems.

Reference will now be made in detail to the exemplary embodiments of the present invention, examples of which are illustrated in the accompanying drawings, wherein like reference symbols refer to like elements throughout.

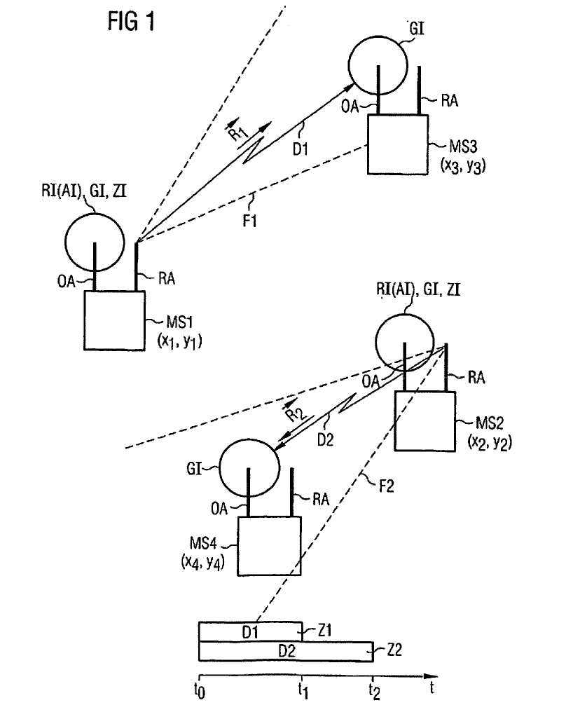

In the scheme shown in FIG. 1 a first emitting station MS1 and a second emitting station MS2 are depicted, as well as a first receiving station MS3 and a second receiving station MS4. The sending and the receiving stations MS1, MS2, MS3, MS4 each have a directional antenna RA and an omnidirectional antenna OA. If the receiving stations MS3, MS4 also have the same equipment which allows the emitting stations MS1, MS2 to execute the invention, the receiving stations MS3, MS4 can function in their turn as emitting stations. Likewise the emitting stations MS1, MS2 can be used as receiving stations if they have the same equipment as the receiving stations MS3, MS4.

The first and second emitting station MS1, MS2 as well as the first and second receiving station MS3, MS4 each have a GPS receiver (GPS: Global Positioning system) to determine their geographical position (x₁,y₁), (x₂y₂), (x₃,y₃), (x₄,y₄). The stations of the radio system MS1, MS2, MS3, MS4 broadcast position information GI which contains their geographical position (x₁,y₁), (x₂,y₂), (x₃,y₃), (x₄,y₄) in each case by their omnidirectional antennas OA. Broadcast in this case means sending out (broadcasting) information. The broadcast sent by a station can be received by all stations which are located in the radio coverage area of the station.

In a given radio system the geographical position of a station of the radio system can of course also be determined and broadcast by a central control station and and/or transmitted to the station for broadcasting.

With their adjustable directional antenna RA the emitting stations MS1, MS2 emit radio signals in a freely selectable spatial direction \vec{R}₁, \vec{R}₂. The aperture under which the electromagnetic radiation is emitted is specified in this case by the antenna characteristics and is for example encoded in an identification number of the relevant directional antenna RA.

The first emitting station MS1 transmits data D1 by its directional antenna RA to the first receiving station MS3. The data D1 is transmitted in a spatial direction \vec{R}₁ and in a first spatial radio area F1. The first spatial radio area F1 of the first emitting station is in this case determined by its geographical position (x₁,y₁), by the spatial direction \vec{R}₁, in which the data D1 is transmitted and by its antenna characteristics. The data D1 is transmitted in a time interval Z1, which lasts from time T₀ to tine T₁. Simultaneously the second emitting station MS2 transmits data D2 to a second receiving station MS4 in a time interval Z2 which lasts from time T₀ to time T₂. The second emitting station MS2 transmits the data D2 to the second receiving station MS4 in a spatial direction \vec{R}₂ and in a second spatial radio area F2. The second spatial radio area F2 of the second emitting station MS2 is defined in this case by its geographical position (x₂, y₂), by the spatial direction \vec{R}₂, in which the data D2 is transmitted, and by its antenna characteristic.

The first and the second emitting station MS1, MS2 transmit their data D1, D2 at least partly simultaneously. In the data transmission no interference can occur between the first and the second emitting station MS1, MS2 since the first and second spatial radio area F1, F2 do not overlap at any of the receiving stations MS3, MS4.

In an ad-hoc network which is not combined with an infrastructure network there is no central device controlling the occupation of transmission resources. The stations of an ad-hoc networks thus organize the timing of their data transmission themselves.

To divide up the transmission resources which result from the data transmission described, the first emitting station MS1 broadcasts its request-to-send via its omnidirectional antenna OA. With the request-to-send the first emitting station MS1 also sends directional information RI, from which the spatial direction in which \vec{R}₁ it provides for the data D1 to be transmitted is derived. The notation RI(AI) in FIG. 1 shows that antenna information AI about the characteristics of the directional antenna RA is contained in directional information RI Direction information RI further contains information ZI about the time interval Z1 provided for transmission of data D1. The broadcasts of the first emitting station MS1 are received by the second emitting station MS2 and used for the occupying transmission resources, i.e. for the definition of the relative timing position of time intervals Z1, Z2.

The second emitting station also checks whether the first spatial radio area F1, which it can determine by the direction information RI and the antenna information AI that it contains about the characteristics of the directional antenna RA of the first emitting station MS1, overlaps at one of the receiving stations MS3, MS4 with the second spatial radio area F2. If there is an overlap the second emitting station MS2 places its time interval Z2 behind the time interval Z1 of the first emitting station to avoid interference. If there is no overlap, as shown in FIG. 1, the first and the second emitting station MS1, MS2 begin transmission of their data D1, D2 at the same point in time t0. Of course the time intervals Z1, Z2 can also begin at different points in time, with the second emitting station MS2 however placing the position of the time interval Z2 so that there is the greatest possible overlap between time intervals Z1, Z2.

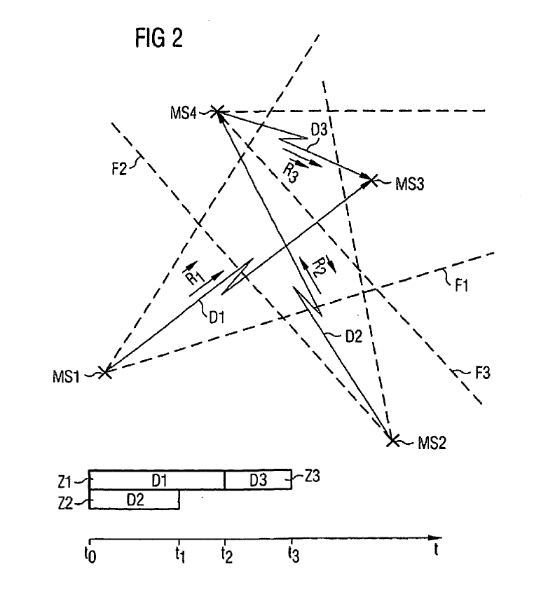

Before the first and the second emitting stations MS1, MS2 transmit their data D1, D2 the second emitting station also sends direction information RI from which the spatial direction \vec{R}₂ in which it is providing for the transmission of its data D2 can be taken. The direction information RI in its turn contains antenna information AI about the characteristics of the directional antenna RA as well as information ZI about the time interval Z2 provided for transmission of the data D2. The broadcasts of the first and second emitting station MS1, MS2 are then received at further stations and used by these to seize their transmission resources. This is shown schematically in an example using a third emitting station MS4 in FIG. 2 which is described later.

The broadcast direction information RI of the first emitting station MS1 reveals the spatial direction \vec{R}₁ in which it wishes to transmit its data D1. To this end the direction information RI contains its geographical position (x₁,y₁) and the geographical position (x₃,y₃) of the first receiving station MS3. From this the second emitting station MS2 can compute the spatial direction \vec{R}₁ in which the first emitting station MS1 would like to transmit its data D1. If the direction information RI contains only the geographical position (x₃,y₃) of the first receiving Station MS3, the second emitting station MS2 can obtain the geographical position (x₁,y₁) of the first emitting station MS1 from the broadcast position information GI. Naturally the direction information RI can also identify just the first sending MS1 and the first receiving station MS3. The second emitting station MS2 can then, on the basis of the position information GI broadcast beforehand in any event by all stations MS1, MS2, MS3, MS4 of the radio system, determine the spatial direction \vec{R}₁. Furthermore the direction information RI can naturally also directly specify the geographical position (x₁ y₁) of the first emitting station and the spatial direction \vec{R}₁, i.e. the direction vector \vec{R}₁.

With regard to the antenna information AI, it should be noted that, without adversely affecting the executability of the invention, this can also be transmitted separately from the direction information RI.

What was stated above naturally applies to the direction information RI of the second emitting station MS2 as well as of further emitting stations.

In the schematic diagram shown in FIG. 2 (crosses indicate the sending and receiving stations MS1, MS2, MS3, MS4 here), which shows another operating state of the radio system from FIG. 1, in addition to the first and second emitting station MS1, MS2, the second receiving station MS4 also transmits data D3 to the first receiving station MS3 in a spatial direction \vec{R}₃ and in a third spatial radio area F3. As already described for the data transmission of the first and second emitting stations MS1, MS2, the second receiving station MS4 receives the request-to-send messages of the first and second emitting station MS1, MS2 before the start of the data transmission and defines the time interval Z3 of its data transmission so that there is no interference with the data D1, D2 of the first and second emitting station MS1, MS2.

The first and the third spatial radio area F1, F3 overlap at the first receiving Station MS3 so that the first emitting station and the second receiving station MS4 may not transmit data D1, D3 simultaneously. Nor may the second emitting station MS2 transmit simultaneously with the second receiving station, since the second receiving station MS4 cannot simultaneously receive data D2 and transmit data D3. For the reasons given, the second receiving station MS3 places its time interval Z3, which lasts from time t2 to time t3 in time behind time interval Z1, Z2 of the first and second emitting station MS1, MS2.

The exemplary embodiments shown can easily be transferred to radio systems with any number of stations, so that the embodiment of the invention is naturally not restricted to a radio system with four stations.

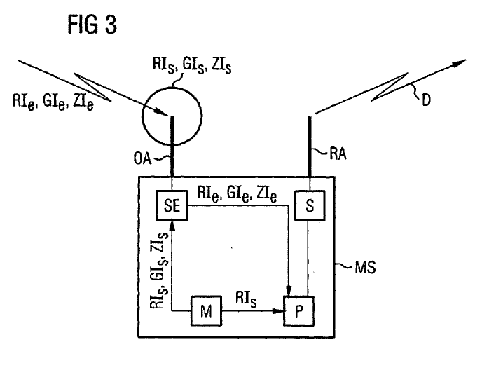

An inventive emitting station MS which at the same time features all the equipment of a receiving station is shown schematically in FIG. 3, so that each emitting station of an inventive radio system can also be used as a receiving station and vice versa.

The emitting station MS has an omnidirectional antenna OA for sending and receiving radio signals, especially for sending inventive broadcasts. Furthermore the emitting station MS features a directional antenna RA with which it can explicitly send data D to a receiving station. The information ZIₑ received through the omnidirectional antenna OA and a transmitter and receiver unit SE about time intervals, direction information RIₑ and position information GIₑ of other stations of the radio system, is evaluated in a unit P together with the own direction information RIₛ of the emitting station MS, i.e. a check is made as to whether the radio area of the emitting station MS overlaps with radio areas of other stations. Data transmission of the emitting station is determined in accordance with the result of this check and unit P then notifies a send unit S when and in which direction the data D is to be transmitted to a receiving station.

The emitting station MS also has a unit M with which it determines its own direction information RIₛ which reveals the spatial direction in which the emitting station MS is providing a transmission of the data D. Further units, not shown, which can however—as in this exemplary embodiment—also be integrated into unit M, determine position information GIs and antenna information of the emitting station MS as well as information ZIₛ about the time interval in which the data D is to be transmitted. All information RIₛ, GIₛ, ZIₛ is transmitted to the send and receive unit SE which then broadcasts the information.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A method for operating a radio system with stations, including a first emitting station equipped with a first directional antenna, comprising
providing for transmission of data from the first emitting station to a first receiving station using the first directional antenna in a first spatial radio area; and
broadcasting first direction information revealing a first spatial direction in which the first emitting station provides for the transmission of data.

16. A method in accordance with claim 15, further comprising:
receiving the first direction information at a second emitting station; and
taking the first direction information into account for occupation of transmission resources by the second emitting station.

17. A method in accordance with claim 16,
wherein the second emitting station is equipped with a second directional antenna and provides for transmission of data to a second receiving station using the second directional antenna in a second spatial radio area,
wherein said taking into account comprises checking, at the second emitting station based on the first direction information, whether the first and the second spatial radio area overlap at one of the receiving stations, and
wherein said method further comprises transmitting data from the first and second emitting stations, only taking place at least partly simultaneously if the first and the second spatial radio areas do not overlap at any receiving stations.

18. A method in accordance with claim 17, wherein the second emitting station broadcasts second direction information revealing a second spatial direction in which the second emitting station provides for transmission of data.

19. A method in accordance with claim 18, wherein the stations of the radio system broadcast position information about their geographical position.

20. A method in accordance with claim 19, further comprising broadcasting from the first emitting station time interval information about a first time interval provided for transmission of data to the first receiving station.

21. A method in accordance with claim 20, further comprising broadcasting from the second emitting station time interval information about a second time interval provided for transmission of data to the second receiving station, after said checking for overlapping of the first and second spatial radio areas.

22. A method in accordance with claim 21, wherein the first and second direction information specify the geographical position of the first and second emitting stations and the first and second spatial directions, respectively.

23. A method in accordance with claim 21, wherein the first and second direction information specify the geographical position of the first and second receiving stations, respectively.

24. A method in accordance with claim 21, wherein the first and second direction information includes antenna information about characteristics of the first and second directional antenna, respectively.

25. A method in accordance with claim 21, wherein the radio system is one of a cellular radio system and a wireless local area network.

26. A method in accordance with claim 25, wherein at least one of the first and second emitting stations and the first and second receiving stations is a mobile station.

27. A method in accordance with claim 18, further comprising broadcasting from the first emitting station time interval information about a first time interval provided for transmission of data to the first receiving station.

28. A method in accordance with claim 27, further comprising broadcasting from the second emitting station time interval information about a second time interval provided for transmission of data to the second receiving station, after said checking for overlapping of the first and second spatial radio areas.

29. A method in accordance with claim 18, wherein the first and second direction information specify the geographical position of the first and second emitting stations and the first and second spatial directions, respectively.

30. A method in accordance with claim 18, wherein the first and second direction information specify the geographical position of the first and second receiving stations, respectively.

31. A method in accordance with claim 18, wherein the radio system is one of a cellular radio system and a wireless local area network.

32. A method in accordance with claim 18, wherein at least one of the first and second emitting stations and the first and second receiving stations is a mobile station.

33. A method in accordance with claim 15, further comprising broadcasting from the first emitting station time interval information about a first time interval provided for transmission of data to the first receiving station.

34-35. (canceled)

36. An emitting station for a radio system also having at least one receiving station, comprising:
at least one directional antenna for transmission of data;
at least one omnidirectional antenna for broadcasts;
means for transmission of data to one of the at least one receiving station in a spatial radio area using the at least one directional antenna; and
means for broadcasting direction information revealing a spatial direction in which the emitting station provides for the transmission of data.

37. A radio system, comprising:
at least one receiving station; and
at least one emitting station, including
at least one directional antenna for transmission of data;
at least one omnidirectional antenna for broadcasts;
means for transmission of data to one of the at least one receiving station in a spatial radio area using the at least one directional antenna; and
means for broadcasting direction information revealing a spatial direction in which the emitting station provides for the transmission of data.
